(19) United States
(12) Patent Application Publication
(10) Pub. No.: US 2015/0207122 A1
(43) Pub. Date: Jul. 23, 2015

(54) SEPARATOR FOR NONAQUEOUS ELECTROLYTE BATTERY, AND NONAQUEOUS ELECTROLYTE BATTERY

(71) Applicant: Teijin Limited, Osaka-shi, Osaka (JP)

(72) Inventor: Takashi Yoshitomi, Yamaguchi (JP)

(73) Assignee: Teijin Limited, Osaka-shi, Osaka (JP)

(21) Appl. No.: 14/413,586

(22) PCT Filed: Jul. 30, 2013
(86) PCT No.: PCT/JP2013/070541

§ 371 Date: Jan. 8, 2015

(30) Foreign Application Priority Data
Jul. 30, 2012 (JP) 2012-168979

(51) Int. Cl. H01M 2/16; H01M 10/0525

(52) U.S. Cl. CPC H01M 2/1686; H01M 2/1653; H01M 10/0525; H01M 2220/30

(57) ABSTRACT

Provided is a separator for a nonaqueous electrolyte battery, including a porous substrate and an adhesive porous layer that is provided on one side or both sides of the porous substrate and contains an adhesive resin. On the surface on the side where the porous substrate has the adhesive porous layer, the separator has a dynamic coefficient of friction of 0.1 or more and 0.6 or less and a ten-point average roughness (Rz) of 1.0 μm or more and 8.0 μm or less.

### TECHNICAL FIELD

The present invention relates to a separator for a nonaqueous electrolyte battery and also to a nonaqueous electrolyte battery.

### BACKGROUND ART

Nonaqueous secondary batteries, such as lithium ion secondary batteries, have been widely used as power sources for portable electronic devices such as laptop computers, mobile phones, digital cameras, and camcorders. Further, these batteries are characterized by having high energy density, and thus their application to automobiles and the like has also been studied in recent years.

With the reduction in size and weight of portable electronic devices, the outer casing of a nonaqueous secondary battery has been simplified. As outer casings, battery cans made of stainless steel were originally used, and then outer casings formed of aluminum cans have been developed. Further, soft pack outer casings formed of aluminum laminate packs have been developed nowadays.

In the case of a soft pack outer casing formed from an aluminum laminate, because the outer casing is soft, a space may be formed between an electrode and a separator during charging and discharging. This causes a decrease in cycle life and thus has been a technical problem. In terms of solving this problem, a technique for bonding an electrode and a separator together is important, and a large number of technical proposals have been made.

As one of the proposals, a technique of using a separator including a polyolefin microporous membrane, which is a conventional separator, and a porous layer made of a polyvinylidene fluoride resin (hereinafter sometimes referred to as “adhesive porous layer”) formed thereon is known (see, e.g., Patent Document 1). When the separator as impregnated with an electrolyte is placed on an electrode and hot-pressed, the adhesive porous layer can function as an adhesive to allow the electrode and the separator to be well joined together. Thus, the cycle life of a soft pack battery can be improved.

In addition, in the case where a battery is produced using a conventional metal can outer casing, electrodes and a separator are placed on top of one another and wound to produce a battery element, and the element is enclosed in a metal can outer casing together with an electrolyte, thereby producing a battery. Meanwhile, in the case where a soft pack battery is produced using a separator like the separator of Patent Document 1 mentioned above, a battery element is produced in the same manner as for the battery having a metal can outer casing mentioned above, then enclosed in a soft pack outer casing together with an electrolyte, and finally subjected to a hot-pressing process, thereby producing a battery. Thus, in the case where a separator including an adhesive porous layer as mentioned above is used, it is possible to produce a battery element in the same manner as for the battery having a metal can outer casing mentioned above. This is also advantageous in that there is no need to greatly change the production process for conventional batteries having a metal can outer casing.

Against this background, various technical proposals have been made in the past for separators made of a polyolefin microporous membrane and an adhesive porous layer laminated thereon. For example, in terms of achieving both the ensuring of sufficient adhesion and ion permeability, Patent Document 1 presents a new technical proposal focusing on the porous structure and thickness of a polyvinylidene fluoride resin layer.

### PRIOR ART DOCUMENTS

### Patent Documents

Patent Document 1: Japanese Patent No. 4127989

### SUMMARY OF THE INVENTION

### Problems that the Invention is to Solve

However, the polyvinylidene fluoride resin used in Patent Document 1 generally tends to have poor slidability. Accordingly, the slidability required for the conveying process in battery production cannot be ensured, and the yield may decrease. In terms of ensuring slidability, it is effective to roughen the surface. This increases the size of surface roughness (i.e., the height and width of depressions and projections), leading to an increase in the volume of depressions that receive an electrolyte. As a result, the electrolyte retention capacity is likely to be improved. When an electrolyte is retained well at the bonding interface between an electrode and a separator, this leads to excellent ion conduction between the two, and the distribution of ions in the electrode active material is made uniform. As a result, cycle characteristics are likely to be improved. Meanwhile, the area of contact with the electrode surface decreases, causing the problem of reduced adhesion to electrodes.

Accordingly, it is important to balance the yield of the production process and the electrolyte retention at the bonding interface with an electrode while ensuring adhesion to electrodes.

The invention has been made against the above background. An object of the invention is to provide a separator for a nonaqueous electrolyte battery, which has excellent adhesion to electrodes, allows for high process yield, and has excellent electrolyte retention, and also a nonaqueous electrolyte battery that allows for high process yield and develops stable cycle characteristics. The invention addresses the achievement of the object.

### Means for Solving the Problems

Specific means for achieving the object mentioned above are as follows.
<1> A separator for a nonaqueous electrolyte battery, including a porous substrate and an adhesive porous layer that is provided on one side or both sides of the porous substrate and contains an adhesive resin,

the separator having, on a surface of the adhesive porous layer, a dynamic coefficient of friction of 0.1 or more and 0.6 or less and a ten-point average roughness (Rz) of 1.0 μm or more and 8.0 μm or less.
<2> The separator for a nonaqueous electrolyte battery according to <1>, wherein the adhesive resin has a weight average molecular weight of 300,000 or more and 3,000,000 or less.
<3> The separator for a nonaqueous electrolyte battery according to <1> or <2>, wherein the adhesive resin is a polyvinylidene fluoride resin that is a copolymer obtained by copolymerizing at least vinylidene fluoride and hexafluoropropylene and has a structural unit derived from hexafluoropropylene in an amount of 0.1% or more and 5% or less by mol.
<4> The separator for a nonaqueous electrolyte battery according to any one of <1> to <3>, wherein the adhesive porous layer contains a filler, the dynamic coefficient of friction is 0.1 or more and 0.4 or less, and the ten-point average roughness Rz is 1.5 μm or more and 8.0 μm or less.
<5> The separator for a nonaqueous electrolyte battery according to any one of <1> to <3>, wherein the adhesive porous layer has a filler content of less than 1 mass % relative to the adhesive resin, the dynamic coefficient of friction is 0.2 or more and 0.6 or less, and the ten-point average roughness Rz is 1.0 μm or more and 6.0 μm or less.
<6> A nonaqueous electrolyte battery including a positive electrode, a negative electrode, and the separator for a nonaqueous electrolyte battery of any one of <1> to <5> disposed between the positive electrode and the negative electrode,

an electromotive force thereof being obtained by lithium doping/dedoping.

### Advantage of the Invention

The invention provides a separator for a nonaqueous electrolyte battery, which has excellent adhesion to electrodes, allows for high process yield, and has excellent electrolyte retention.

The invention also provides a nonaqueous electrolyte battery that allows for high process yield and develops stable cycle characteristics.

### BRIEF DESCRIPTION OF THE DRAWINGS

FIG. 1 is a schematic cross-sectional view showing a separator, in which an adhesive porous layer surface adheres to an electrode surface.

### EXPLANATION OF REFERENCE NUMERALS

11: Porous substrate

13: Adhesive porous layer

15: Electrode

17: Electrolyte

### MODE FOR CARRYING OUT THE INVENTION

Hereinafter, the separator for a nonaqueous electrolyte battery of the invention and a nonaqueous electrolyte battery using the same will be described in detail. Incidentally, a numerical range expressed using “to” herein shows a range including the numerical values before and after “to” as the minimum and the maximum, respectively.

### <Separator for Nonaqueous Electrolyte Battery>

The separator for a nonaqueous electrolyte battery of the invention includes a porous substrate and an adhesive porous layer that is provided on one side or both sides of the porous substrate and contains an adhesive resin. The separator has, on the surface of the adhesive porous layer, a dynamic coefficient of friction of 0.1 or more and 0.6 or less and a ten-point average roughness (Rz) of 1.0 μm or more and 8.0 μm or less.

Examples of using a polyvinylidene fluoride resin or the like as an adhesive resin for a separator have been conventionally known. In the case where such a resin is used for the outermost layer of a separator, which adheres to an electrode, for example, it is likely that the slidability required for the conveying process in battery production cannot be ensured, resulting in a decrease in the yield. Therefore, in terms of ensuring slidability, it is effective to roughen the surface conditions of the conveying surface, that is, reduce the dynamic coefficient of friction. When the surface roughness of the outermost layer of a separator, which serves as the conveying surface, is increased, the surface has larger depressions and projections, whereby electrolyte retention is facilitated. However, when bonded to an electrode, the separator has a reduced bonding area, whereby adhesion to electrodes decreases. That is, there is a conflicting relation between the improvement of production yield and electrolyte retention and the improvement of adhesion to electrodes.

In light of this situation, in the invention, the dynamic coefficient of friction on the surface of the adhesive porous layer that serves as the outermost layer as seen from the porous substrate is within a predetermined range to ensure the slidability for maintaining high process yield, while the surface roughness (Rz) of the layer satisfies a predetermined range. As a result, process yield, adhesion to electrodes, and electrolyte retention are balanced. The invention has a technical value in that such conflicting characteristics are compatible in a well-balanced manner.

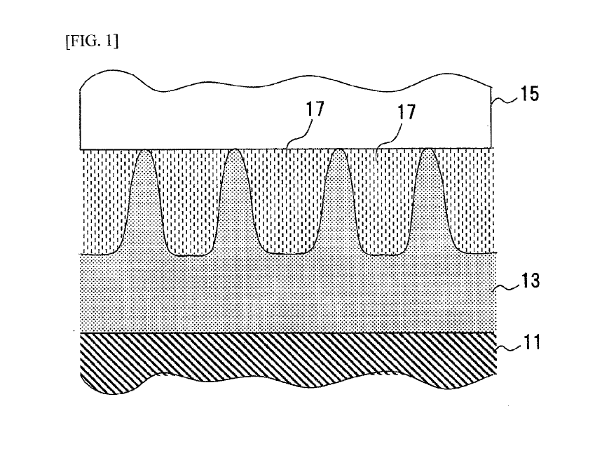

The invention will be specifically described with reference to FIG. 1. As shown in FIG. 1, an electrode 15 is placed in contact with an adhesive porous layer 13 on a porous substrate 11, and the ends of projections of the depressions and projections on the adhesive porous layer 13 adhere to the electrode surface and are fixed.

Here, in the case where Rz is too small, the adhesive porous layer has a large number of projections, and the area of the bonding region increases, whereby adhesion to electrodes is improved. Meanwhile, because the proportion of the area of the bonding region is high, the dynamic coefficient of friction becomes too high, whereby the yield of the production process decreases. In addition, the region that receives the electrolyte 17 of FIG. 1 is small, whereby the electrolyte retention is also deteriorated.

On the contrary, in the case where Rz is too high, the adhesive porous layer has a small number of projections, and the area of the bonding region decreases. Accordingly, the proportion of the area of the bonding region is low, and the dynamic coefficient of friction decreases, resulting in the excellent yield of the production process. In addition, the region that receives the electrolyte 17 of FIG. 1 is also large, resulting in excellent electrolyte retention. However, adhesion to electrodes decreases.

As mentioned above, in the invention, the dynamic coefficient of friction and Rz on the surface of the adhesive porous layer, which adheres to an electrode, are adjusted to be within predetermined ranges in a well-balanced manner. As a result, process yield, adhesion, and electrolyte retention can be balanced. Accordingly, when a battery is produced, stable cycle characteristics are obtained.

In the separator for a nonaqueous electrolyte battery of the invention, the dynamic coefficient of friction on the surface of the adhesive porous layer provided on one side and/or the other side of the porous substrate is within a range of 0.1 or more and 0.6 or less.

In the invention, in an embodiment in which the adhesive porous layer is present only on one side of the porous substrate, it is necessary that the dynamic coefficient of friction and Rz on the surface on the side where the porous substrate has the adhesive porous layer satisfy the above ranges. In addition, in an embodiment in which the adhesive porous layer is present on both sides of the porous substrate, it is necessary that the dynamic coefficient of friction and Rz on the surface of one of the adhesive porous layers on the porous substrate satisfy the above ranges, but it is preferable that both adhesive porous layers satisfy the above ranges.

In the case where the dynamic coefficient of friction is less than 0.1, the surface of the adhesive porous layer is rough. Although this is advantageous in terms of retaining an electrolyte and of process yield, the area of the bonding region is too small, resulting in a decrease in adhesion. From such a point of view, the dynamic coefficient of friction is more preferably 0.15 or more, and still more preferably 0.2 or more. In addition, in the case where the dynamic coefficient of friction is more than 0.6, conversely, the surface of the adhesive porous layer is smooth. Although this is advantageous in terms of adhesion, surface irregularities are too small, resulting in significant decreases in electrolyte retention and process yield. From such a point of view, the dynamic coefficient of friction is more preferably 0.55 or less, and still more preferably 0.5 or less.

A dynamic coefficient of friction is a value measured by the method in accordance with JIS K7125. Specifically, a dynamic coefficient of friction in the invention is measured using a surface property tester manufactured by HEIDON.

In addition, in the invention, the ten-point average roughness Rz of the adhesive porous layer provided on one side and/or the other side of the porous substrate is within a range of 1.0 μm or more and 8.0 μm or less. In the case where the Rz is less than 1.0 μm, the area of the bonding region is large. Although this is advantageous in terms of adhesion, the yield of the production process decreases, and also electrolyte retention is deteriorated. From such a point of view, Rz is more preferably 1.5 μm or more, and still more preferably 2.0 μm or more. In addition, in the case where the Rz is more than 8.0 μm, conversely, the process yield is excellent, and the electrolyte retention is also excellent, but adhesion is significantly reduced. From such a point of view, Rz is more preferably 7.5 μm or less, and still more preferably 7.0 μm or less.

Ten-point average roughness (Rz) is a value measured by the method in accordance with JIS B 0601-1994 (or Rzjis of JIS B 0601-2001). Specifically, Rz in the invention is measured using ET4000 manufactured by Kosaka Laboratory Ltd. Incidentally, the measurement is performed under the following conditions: measurement length: 1.25 mm, measurement speed: 0.1 mm/sec, temperature and humidity: 25° C., 50% RH.

Incidentally, the methods for controlling the dynamic coefficient of friction and Rz on the surface of the adhesive porous layer are not particularly limited. For example, they can be controlled by the addition of a filler to the adhesive porous layer and the amount of addition, the size of the filler to be added (diameter, etc.), the molecular weight of the adhesive resin, the coagulation temperature and the concentration of a phase-separating agent at the time of the formation of an adhesive porous layer, etc.

In the case where the adhesive porous layer contains a filler together with an adhesive resin, in order for adhesion to electrodes, process yield, and electrolyte retention to be even more suitably balanced, the dynamic coefficient of friction is preferably within a range of 0.1 or more and 0.4 or less, and the ten-point average roughness Rz is preferably 1.5 μm or more and 8.0 μm or less. In this case, the lower limit of the dynamic coefficient of friction is more preferably 0.12 or more, and still more preferably 0.15 or more. The upper limit of the dynamic coefficient of friction is more preferably 0.35 or less. The lower limit of the ten-point average roughness Rz is preferably 2.0 μm or more, and still more preferably 2.5 μm or more. The upper limit of the ten-point average roughness Rz is preferably 7.5 μm or less, and still more preferably 7.0 μm or less. At this time, the content of the filler in the adhesive porous layer is preferably 1 mass % or more and 90 mass % or less relative to the total solids. However, the preferred filler content changes according to the average particle size of the filler to be used.

In the case where a filler is contained, the dynamic coefficient of friction and the value Rz can be adjusted to be within the above ranges by adjusting the weight average molecular weight of the adhesive resin (in particular, polyvinylidene fluoride resin), the coagulation temperature at the time of immersion in a coagulation liquid to cause solidification, the concentration of a phase-separating agent that induces phase separation at the time of immersion in a coagulation liquid, the average particle size of the filler, its content, etc.

Meanwhile, in the case where the adhesive porous layer does not positively contain a filler, in order for adhesion to electrodes, process yield, and electrolyte retention to be even more suitably balanced, the dynamic coefficient of friction is preferably within a range of 0.2 or more and 0.6 or less, and the ten-point average roughness Rz is preferably 1.0 μm or more and 6.0 μm or less. In this case, the lower limit of the dynamic coefficient of friction is more preferably 0.22 or more. The upper limit of the dynamic coefficient of friction is more preferably 0.55 or less, and still more preferably 0.50 or less. The lower limit of the ten-point average roughness Rz is preferably 1.1 μm or more, and still more preferably 1.2 μm or more. The upper limit of the ten-point average roughness Rz is more preferably 4.0 μm or less. At this time, the content of the filler in the adhesive porous layer is preferably less than 1 mass % relative to the total solids, and it is still more preferable that no filler is contained (0 mass %).

In the case where the adhesive porous layer does not positively contain a filler, the dynamic coefficient of friction and the value Rz can be adjusted to be within the above ranges by adjusting the weight average molecular weight of the adhesive resin (in particular, polyvinylidene fluoride resin), the coagulation temperature at the time of immersion in a coagulation liquid to cause solidification, the concentration of a phase-separating agent that induces phase separation at the time of immersion in a coagulation liquid, etc.

### [Porous Substrate]

The porous substrate in the invention means a substrate having pores or voids inside. Examples of such substrates include microporous membranes, porous sheets made of a fibrous material, such as nonwoven fabrics and paper-like sheets, and composite porous sheets including such a microporous membrane or porous sheet as well as one or more other porous layers laminated thereon. Incidentally, a microporous membrane means a membrane having a large number of micropores inside and configured such that the micropores are connected to allow gas or liquid to pass from one side to the other side.

The material forming the porous substrate may be an organic material or an inorganic material as long as it is an electrically insulating material. In terms of imparting a shutdown function to the porous substrate, it is preferable that the material forming the porous substrate is a thermoplastic resin.

A shutdown function herein refers to the following function: upon an increase in battery temperature, a constituent material melts and closes pores of the porous substrate, thereby blocking the movement of ions to prevent the battery from thermal runaway.

As the thermoplastic resin, a thermoplastic resin having a melting point of less than 200° C. is suitable, and polyolefins are particularly preferable.

As a porous substrate using a polyolefin, a polyolefin microporous membrane is preferable.

As the polyolefin microporous membrane, among polyolefin microporous membranes that have been applied to conventional nonaqueous electrolyte battery separators, those having sufficient mechanical properties and ion permeability can be preferably used.

In terms of developing a shutdown function, it is preferable that the polyolefin microporous membrane contains polyethylene, and it is preferable that the polyethylene content is 95 mass % or more.

In addition to the above, in terms of imparting heat resistance that prevents the membrane from easily breaking when exposed to high temperatures, a polyolefin microporous membrane containing polyethylene and polypropylene is preferable. An example of such a polyolefin microporous membrane is a microporous membrane in which both polyethylene and polypropylene are present in one layer. In terms of achieving both a shutdown function and heat resistance, it is preferable that the microporous membrane contains 95 mass % or more polyethylene and 5 mass % or less polypropylene. In addition, in terms of achieving both a shutdown function and heat resistance, it is also preferable that the polyolefin microporous membrane has a laminated structure including at least two layers, configured such that at least one layer contains polyethylene, while at least one layer contains polypropylene.

It is preferable that the polyolefin contained in the polyolefin microporous membrane has a weight average molecular weight of 100,000 to 5,000,000. When the weight average molecular weight is 100,000 or more, sufficient mechanical properties can be ensured. Meanwhile, a weight average molecular weight of 5,000,000 or less leads to excellent shutdown characteristics and also facilitates membrane formation.

A polyolefin microporous membrane can be produced by the following methods, for example. That is, a method including (i) extruding a molten polyolefin resin from a T-die to form a sheet, (ii) subjecting the sheet to a crystallization treatment, (iii) stretching the same, and further (iv) heat-treating the stretched sheet to form a microporous membrane can be mentioned. As an alternative method, a method including (i) melting a polyolefin resin together with a plasticizer such as liquid paraffin and extruding the melt from a T-die, followed by cooling to form a sheet, (ii) stretching the sheet, (iii) extracting the plasticizer from the sheet, and further (iii) heat-treating the sheet to form a microporous membrane can also be mentioned, for example.

Examples of porous sheets made of a fibrous material include porous sheets made of polyesters such as polyethylene terephthalate; polyolefins such as polyethylene and polypropylene; heat-resistant polymers such as aromatic polyamide, polyimide, polyethersulfone, polysulfone, polyether ketone, and polyetherimide; and like fibrous materials. Examples also include porous sheets made of a mixture of the above fibrous materials.

A composite porous sheet may be configured to include a microporous membrane or a porous sheet made of a fibrous material as well as a functional layer laminated thereon. Such a composite porous sheet is preferable in that further functions can be imparted by the functional layer. In terms of imparting heat resistance, for example, the functional layer may be a porous layer made of a heat-resistant resin or a porous layer made of a heat-resistant resin and an inorganic filler. The heat-resistant resin may be one or more kinds of heat-resistant polymers selected from aromatic polyamide, polyimide, polyethersulfone, polysulfone, polyether ketone, and polyetherimide. As the inorganic filler, metal oxides such as alumina and metal hydroxides such as magnesium hydroxide can be preferably used.

Incidentally, examples of compositing techniques include a method in which a microporous membrane or a porous sheet is coated with a functional layer, a method in which a microporous membrane or a porous sheet and a functional layer are joined together using an adhesive, and a method in which a microporous membrane or a porous sheet and a functional layer are bonded together by thermocompression.

In terms of obtaining excellent mechanical properties and internal resistance, it is preferable that the porous substrate has a thickness within a range of 5 μm to 25 μm.

In terms of preventing short circuits in a battery and obtaining sufficient ion permeability, it is preferable that the porous substrate has a Gurley number (JIS P8117) within a range of 50 sec/100 cc or more and 800 sec/100 cc or less.

In terms of improving the production yield, it is preferable that the porous substrate has a puncture resistance of 300 g or more.

### [Adhesive Porous Layer]

The adhesive porous layer in the invention is a layer having a porous structure in which a large number of micropores are present inside, and the micropores are connected to each other to allow gas or liquid to pass from one side to the other side.

The adhesive porous layer is provided as the outermost layer (s) of the separator on one side or both sides of the porous substrate. The adhesive porous layer allows for bonding to an electrode. That is, when the separator and an electrode are stacked and hot-pressed, the adhesive porous layer can bond the separator to the electrode. In the case where the separator for a nonaqueous electrolyte battery of the invention has the adhesive porous layer only on one side of the porous substrate, the adhesive porous layer adheres to either of the positive electrode or the negative electrode. In addition, in the case where the separator for a nonaqueous electrolyte battery of the invention has the adhesive porous layer on both sides of the porous substrate, the adhesive porous layer adheres to both the positive electrode and the negative electrode. In terms of providing a battery with excellent cycle characteristics, it is preferable that the adhesive porous layer is provided on both sides of the porous substrate rather than only one side. This is because when the adhesive porous layer is present on both sides of the porous substrate, both sides of the separator adhere well to both electrodes via the adhesive porous layer.

In the invention, in the case where the adhesive porous layer is applied to and formed on both sides of the porous substrate, it is preferable that the total coat weight of the adhesive porous layer on both sides of the porous substrate is 1.0 g/m² to 3.0 g/m². Here, with respect to “the total coat weight on both sides of the porous substrate” of the adhesive porous layer, in the case where the adhesive porous layer is provided on one side of the porous substrate, it refers to the coat weight on one side, while in the case where the adhesive porous layer is provided on both sides of the porous substrate, it refers to the total of the coat weights on both sides.

When the coat weight is 1.0 g/m² or more, this leads to excellent adhesion to electrodes and provides a battery with good cycle characteristics. Meanwhile, when the coat weight is 3.0 g/m² or less, this leads to excellent ion permeability and provides a battery with good load characteristics.

In the case where the adhesive porous layer is provided on both sides of the porous substrate, the difference between the coat weight on one side and the coat weight on the other side is preferably 20% or less of the total coat weight on both sides. When the difference is 20% or less, the separator is resistant to curling. This results in good handleability, and also the problem of decreased cycle characteristics is unlikely to occur.

It is preferable that the thickness of the adhesive porous layer on one side of the porous substrate is 0.5 μm to 5 μm. When the thickness is 0.5 μm or more, this leads to excellent adhesion to electrodes and provides a battery with excellent cycle characteristics. When the thickness is 5 μm or less, this leads to excellent ion permeability and provides a battery with excellent load characteristics. The thickness of the adhesive porous layer on one side of the porous substrate is more preferably 1 μm to 5 μm, and still more preferably 2 μm to 5 μm.

In the invention, in terms of ion permeability, it is preferable that the structure of the adhesive porous layer is sufficiently porous. Specifically, it is preferable that the porosity is 30% to 60%. When the porosity is 30% or more, ion permeability is excellent, leading to even better battery characteristics. In addition, a porosity of 60% or less provides mechanical properties sufficient to prevent the porous structure from being destroyed upon bonding to an electrode by hot pressing. In addition, a porosity of 60% or less provides low surface porosity, leading to an increase in the area occupied by the adhesive resin (preferably polyvinylidene fluoride resin), whereby even better adhesion strength can be ensured. Incidentally, the porosity of the adhesive porous layer is more preferably within a range of 30 to 50%.

It is preferable that the adhesive porous layer has an average pore size of 1 nm to 100 nm. When the average pore size of the adhesive porous layer is 100 nm or less, a porous structure in which uniform pores are uniformly dispersed is likely to be obtained, whereby points of bonding to an electrode can be uniformly dispersed, resulting in excellent adhesion. This also results in uniform ion migration. Thus, even better cycle characteristics can be obtained, and also further excellent load characteristics can be obtained. Meanwhile, although it is preferable, in terms of uniformity, that the average pore size is as small as possible, it is practically difficult to form a porous structure of less than 1 nm. In addition, in the case where the adhesive porous layer is impregnated with an electrolyte, the resin (e.g., polyvinylidene fluoride resin) may swell, and, when the average pore size is too small, the pores may be closed due to swelling, resulting in loss of ion permeability. Also from such a point of view, it is preferable that the average pore size is 1 nm or more.

The average pore size of the adhesive porous layer is more preferably 20 nm to 100 nm.

In terms of cycle characteristics, it is preferable that the polyvinylidene fluoride resin in the adhesive porous layer has a fibril diameter within a range of 10 nm to 1,000 nm.

The adhesive porous layer in the invention contains at least an adhesive resin and preferably contains a filler. In addition, the adhesive porous layer may be formed further using other components as necessary.

### (Adhesive Resin)

The adhesive resin contained in the adhesive porous layer is not particularly limited as long as it can adhere to electrodes. Preferred examples thereof include polyvinylidene fluoride, polyvinylidene fluoride copolymers, styrene-butadiene copolymers, homopolymers and copolymers of vinyl nitriles such as acrylonitrile and methacrylonitrile, polyethers such as polyethylene oxide and polypropylene oxide, and polyvinyl alcohols.

The adhesive porous layer may contain only one kind of adhesive resin, or may also contain two or more kinds.

In terms of adhesion to electrodes, it is preferable that the adhesive resin contained in the adhesive porous layer is a polyvinylidene fluoride resin.

Examples of polyvinylidene fluoride resins include a homopolymer of vinylidene fluoride (i.e., polyvinylidene fluoride); copolymers of vinylidene fluoride and another copolymerizable monomer (polyvinylidene fluoride copolymers); and mixtures thereof.

Examples of monomers copolymerizable with vinylidene fluoride include tetrafluoroethylene, hexafluoropropylene (HFP), trifluoroethylene, trichloroethylene, and vinyl fluoride. They can be used alone, or it is also possible to use two or more kinds.

A polyvinylidene fluoride resin is obtained by emulsion polymerization or suspension polymerization.

Among polyvinylidene fluoride resins, in terms of adhesion to electrodes, copolymers obtained by copolymerizing at least vinylidene fluoride and hexafluoropropylene, which have a structural unit derived from hexafluoropropylene in an amount of 0.1 mol % or more and 5 mol % or less (preferably 0.5 mol % or more and 2 mol % or less) by mol, are more preferable.

It is preferable that the adhesive resin (in particular, polyvinylidene fluoride resin) has a weight average molecular weight (Mw) within a range of 300,000 to 3,000,000. When the weight average molecular weight is 300,000 or more, mechanical properties that can withstand the treatment for bonding to electrodes can be ensured for the adhesive porous layer, and sufficient adhesion can be obtained. From such a point of view, the weight average molecular weight of the adhesive resin is preferably 500,000 or more, and still more preferably 600,000 or more. Meanwhile, when the weight average molecular weight is 3,000,000 or less, viscosity at the time of formation of the adhesive porous layer does not become too high, leading to good formability and crystal formation, resulting in excellent porousness. From such a point of view, the weight average molecular weight of the adhesive resin is preferably 2,000,000 or less, and still more preferably 1,500,000 or less.

Incidentally, the weight average molecular weight (Dalton) of the adhesive resin is a polystyrene-equivalent molecular weight measured by gel permeation chromatography (hereinafter sometimes referred to as GPC) under the following conditions.

### <Conditions>

GPC: Alliance GPC 2000 [manufactured by Waters Corporation]

Column: TSKgel GMH₆-HT ×2+TSKgel GMH₆-HTL ×2 [manufactured by Tosoh Corporation]

Mobile phase solvent: o-Dichlorobenzene

Reference sample: Monodisperse polystyrene [manufactured by Tosoh Corporation]

Column temperature: 140° C.

### [Filler]

The adhesive porous layer may contain a filler made of an inorganic substance or an organic substance.

The presence of a filler in the adhesive porous layer is effective in adjusting the dynamic coefficient of friction and Rz of the separator (in particular, the adhesive porous layer that comes into contact with an electrode) to be within the above ranges, whereby the slidability and heat resistance of the separator are improved.

Examples of organic fillers include fine particles of various crosslinked polymers, such as crosslinked polyacrylic acid, crosslinked polyacrylic ester, crosslinked polymethacrylic acid, crosslinked polymethacrylic ester, crosslinked polymethyl methacrylate, crosslinked polysilicone (polymethylsilsesquioxane etc.), crosslinked polystyrene, crosslinked polydivinylbenzene, crosslinked styrene-divinylbenzene copolymers, polyimide, melamine resin, phenol resin, and benzoguanamine-formaldehyde condensates; and fine particles of heat-resistant polymers such as polysulfone, polyacrylonitrile, aramid, polyacetal, and thermoplastic polyimide. In addition, the organic resins (polymers) forming the organic fine particles may be mixtures, modified products, derivatives, copolymers (random copolymers, alternating copolymers, block copolymers, graft copolymers), or crosslinked products (in the case of the heat-resistant polymers) of the materials mentioned above.

Among them, it preferable that the filler is at least one resin selected from the group consisting of crosslinked polyacrylic acid, crosslinked polyacrylic ester, crosslinked polymethacrylic acid, crosslinked polymethacrylic ester, crosslinked polymethyl methacrylate, and crosslinked polysilicone (polymethylsilsesquioxane, etc.).

Examples of inorganic fillers include metal hydroxides such as aluminum hydroxide, magnesium hydroxide, calcium hydroxide, chromium hydroxide, zirconium hydroxide, nickel hydroxide, and boron hydroxide; metal oxides such as alumina, magnesium oxide, and zirconia; carbonates such as calcium carbonate and magnesium carbonate; sulfates such as barium sulfate and calcium sulfate; and clay minerals such as calcium silicate and talc.

Among them, it is preferable that the filler is made of at least either a metal hydroxide or a metal oxide. In terms of imparting flame retardancy or of antistatic effects, it is particularly preferable to use a metal hydroxide. Incidentally, the above various fillers may be used alone, or it is also possible to use a combination of two or more kinds.

Among them, magnesium hydroxide is preferable. In addition, an inorganic filler surface-modified with a silane coupling agent or the like may also be used.

In order for characteristics to be balanced such that slidability during production is enhanced to enhance the yield, and adhesion to electrodes and electrolyte retention are also satisfied, it is preferable that the filler has an average particle size of 0.1 μor more and 5.0 μm or less. The average particle size of the filler is more preferably within a range of 0.5 μm or more and 3.0 μm or less.

Incidentally, the average particle size of a filler was measured using a laser diffraction particle size distribution analyzer. Water was used as a dispersion medium for inorganic fine particles, and a small amount of a nonionic surfactant “Triton X-100” was used as a dispersing agent. In the obtained volume particle size distribution, the central particle size (D50) was defined as the average particle size.

It is preferable that the content of the filler in the adhesive porous layer is 1 mass % or more and 90 mass % or less relative to the adhesive resin. When the filler content is 1 mass % or more, the dynamic coefficient of friction and Rz can be more easily adjusted to be within the ranges mentioned above. Thus, slidability is imparted, which is advantageous for the improvement of process yield, and also better electrolyte retention is provided. In addition, a filler content of 90 mass % or less is preferable in terms of balancing adhesion to electrodes, process yield, and electrolyte retention.

In terms of appropriately controlling the dynamic coefficient of friction and Rz, thereby balancing adhesion to electrodes, process yield, and electrolyte retention, the filler content is more preferably 20 mass % or more and 80 mass % or less.

### [Characteristics of Separator]

In terms of mechanical strength and of energy density as a battery, it is preferable that the separator for a nonaqueous electrolyte battery of the invention has an entire thickness of 5 μm to 35 μm.

In terms of mechanical strength, handleability, and ion permeability, it is preferable that the separator for a nonaqueous electrolyte battery of the invention has a porosity of 30% to 60%.

In terms of achieving a good balance between mechanical strength and membrane resistance, it is preferable that the separator for a nonaqueous electrolyte battery of the invention has a Gurley number (JIS P8117) of 50 sec/100 cc to 800 sec/100 cc.

In terms of ion permeability, in the separator for a nonaqueous electrolyte battery of the invention, it is preferable that the difference between the Gurley number of the porous substrate and the Gurley number of the separator including an adhesive porous layer provided on the porous substrate is 300 sec/100 cc or less, more preferably 150 sec/100 cc or less, and still more preferably 100 sec/100 cc or less.

In terms of the load characteristics of a battery, it is preferable that the separator for a nonaqueous electrolyte battery of the invention has a membrane resistance of 1 ohm·cm² to 10 ohm·cm². Membrane resistance herein refers to the resistance of the separator as impregnated with an electrolyte, and is measured by an alternating-current method. The resistance naturally varies depending on the kind of electrolyte and the temperature, and the above value is a value measured at 20° C. using 1 M LiBF₄-propylene carbonate/ethylene carbonate (mass ratio: 1/1) as the electrolyte.

In terms of ion permeability, it is preferable that the separator for a nonaqueous electrolyte battery of the invention has a tortuosity of 1.5 to 2.5.

### [Method for Producing Separator]

The separator for a nonaqueous electrolyte battery of the invention can be produced, for example, by a method in which a porous substrate is coated thereon with a coating liquid containing a resin, such as a polyvinylidene fluoride resin, to form a coating layer, and then the resin of the coating layer is solidified, thereby integrally forming an adhesive porous layer on the porous substrate.

The following describes the case where the adhesive porous layer is made of a polyvinylidene fluoride resin.

An adhesive porous layer using a polyvinylidene fluoride resin as an adhesive resin can be preferably formed by the following wet coating method, for example.

The wet coating method is a film formation method including (i) a step of dissolving a polyvinylidene fluoride resin in a suitable solvent to prepare a coating liquid, (ii) a step of coating a porous substrate with the coating liquid, (iii) a step of immersing the porous substrate in a suitable coagulation liquid to induce phase separation and solidify the polyvinylidene fluoride resin, (iv) a step of washing with water, and (v) a step of drying, thereby forming a porous layer on the porous substrate. The details of a wet coating method suitable for the invention are as follows.

As a solvent that dissolves a polyvinylidene fluoride resin (hereinafter sometimes referred to as “good solvent”) used for the preparation of a coating liquid, it is preferable to use a polar amide solvent such as N-methylpyrrolidone, dimethylacetamide, dimethylformamide, or dimethylformamide.

In terms of forming an excellent porous structure, in addition to the good solvent, it is preferable to mix a phase-separating agent that induces phase separation. Examples of phase-separating agents include water, methanol, ethanol, propyl alcohol, butyl alcohol, butanediol, ethylene glycol, propylene glycol, and tripropylene glycol. It is preferable that the phase-separating agent is added within a range where viscosity suitable for coating can be ensured.

In terms of forming an excellent porous structure, it is preferable that the solvent is a mixed solvent containing to 95 mass % a good solvent and 5 to 40 mass % a phase-separating agent.

In terms of forming an excellent porous structure, it is preferable that the coating liquid contains the polyvinylidene fluoride resin at a concentration of 3 to 10 mass %.

In the case where a filler or other components are added to the adhesive porous layer, they may be mixed with or dissolved in the coating liquid.

In general, a coagulation liquid contains the good solvent and phase-separating agent used for the preparation of a coating liquid and water. In terms of production, it is preferable that the mixing ratio between the good solvent and the phase-separating agent is determined according to the mixing ratio in the mixed solvent used for dissolving a polyvinylidene fluoride resin. In terms of the formation of a porous structure and productivity, the suitable concentration of water is 40 mass % to 90 mass %. It is preferable that the temperature of the coagulation liquid is 0 to 43° C.

The coating of a porous substrate with the coating liquid may be performed using a conventional coating technique, such as a Mayer bar, a die coater, a reverse roll coater, or a gravure coater. In the case where an adhesive porous layer is formed on both sides of the porous substrate, in terms of productivity, it is preferable that both sides of the substrate are simultaneously coated with the coating liquid.

In addition to the wet coating method mentioned above, the adhesive porous layer can also be produced by a dry coating method. A dry coating method herein is a method in which, for example, a porous substrate is coated with a coating liquid containing a polyvinylidene fluoride resin and a solvent, and then the resulting coating layer is dried to volatilize the solvent away, thereby giving a porous layer. However, as compared with the wet coating method, the dry coating method tends to give a dense coating layer. Accordingly, in terms of obtaining an excellent porous structure, the wet coating method is more preferable.

The separator for a nonaqueous electrolyte battery of the invention can also be produced by a method in which an adhesive porous layer is formed as an independent sheet, then the adhesive porous layer is placed on a porous substrate, and they are composited by thermocompression bonding or using an adhesive. The method for producing an adhesive porous layer as an independent sheet may be a method in which a release sheet is coated thereon with a coating liquid containing a resin, then an adhesive porous layer is formed by the wet coating method or dry coating method mentioned above, and the adhesive porous layer is peeled off the release sheet.

### <Nonaqueous Electrolyte Battery>

The nonaqueous electrolyte battery of the invention is a nonaqueous electrolyte battery whose electromotive force is obtained by lithium doping/dedoping, and is configured to include a positive electrode, a negative electrode, and the separator for a nonaqueous electrolyte battery of the invention mentioned above. Incidentally, doping means occlusion, support, adsorption, or intercalation, and refers to the phenomenon that lithium ions enter the active material of an electrode such as a positive electrode.

A nonaqueous electrolyte battery is configured such that a battery element, which includes an electrolyte-impregnated structure having a negative electrode and a positive electrode facing each other via a separator, is enclosed in an outer casing material. The nonaqueous electrolyte battery of the invention is suitable for a nonaqueous electrolyte secondary battery, particularly a lithium ion secondary battery.

The nonaqueous electrolyte battery of the invention includes, as a separator, the separator for a nonaqueous electrolyte battery of the invention mentioned above, and thus has excellent adhesion between the electrodes and the separator. At the same time, the yield of the production process is high, and electrolyte retention is also excellent. Accordingly, the nonaqueous electrolyte battery of the invention develops stable cycle characteristics.

The positive electrode may be configured such that an active material layer containing a positive electrode active material and a binder resin is formed on a collector. The active material layer may further contain a conductive auxiliary.

Examples of positive electrode active materials include lithium-containing transition metal oxides. Specific examples thereof include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂, and LiAl_{1/4}Ni_{3/4}O₂.

Examples of binder resins include polyvinylidene fluoride resins and styrene-butadiene copolymers.

Examples of conductive auxiliaries include carbon materials such as acetylene black, ketjen black, and graphite powder.

Examples of collectors include aluminum foils, titanium foils, and stainless steel foils having a thickness of 5 μm to 20 μm.

In the nonaqueous electrolyte battery of the invention, in the case where the separator includes an adhesive porous layer containing a polyvinylidene fluoride resin, and the adhesive porous layer is disposed on the positive electrode side, because the polyvinylidene fluoride resin has excellent oxidation resistance, it is easy to apply a positive electrode active material that can be operated at a high voltage of 4.2 V or more, such as LiMn_{1/2}Ni_{1/2}O₂ or LiCo_{1/3}Mn_{1/3}Ni_{1/3}O₂; thus, this is advantageous.

The negative electrode may be configured such that an active material layer containing a negative electrode active material and a binder resin is formed on a collector. The active material layer may further contain a conductive auxiliary.

Examples of negative electrode active materials include materials capable of electrochemically storing lithium. Specific examples thereof include carbon materials, silicon, tin, aluminum, and Wood's alloy.

Examples of binder resins include polyvinylidene fluoride resins and styrene-butadiene copolymers.

Examples of conductive auxiliaries include carbon materials such as acetylene black, ketjen black, and graphite powder.

Examples of collectors include copper foils, nickel foils, and stainless steel foils having a thickness of 5 μm to 20 μm.

In addition, instead of such a negative electrode, a metal lithium foil may also be used as the negative electrode.

The electrolyte is a solution obtained by dissolving a lithium salt in a nonaqueous solvent.

Examples of lithium salts include LiPF₆, LiBF₄, and LiClO₄.

Examples of nonaqueous solvents include cyclic carbonates such as ethylene carbonate, propylene carbonate, fluoroethylene carbonate, and difluoroethylene carbonate; linear carbonates such as dimethyl carbonate, diethyl carbonate, ethyl methyl carbonate, and fluorine substitutions thereof; and cyclic esters such as γ-butyrolactone and γ-valerolactone. They may be used alone or may also be mixed and used.

As the electrolyte, one obtained by mixing a cyclic carbonate and a linear carbonate in a mass ratio (cyclic carbonate/linear carbonate) of 20/80 to 40/60 and dissolving a lithium salt therein at 0.5 M to 1.5 M is preferable.

Examples of outer casing materials includes metal cans and packs formed from an aluminum laminate film.

The shape of batteries may be prismatic, cylindrical, coin-type, etc., and the separator for a nonaqueous electrolyte battery of the invention is suitable for any shape.

### EXAMPLES

Hereinafter, the invention will be described in further detail with reference to examples. However, within the gist thereof, the invention is not limited to the following examples. Incidentally, unless otherwise noted, “parts” are by mass.

### [Measurement/Evaluation]

Separators and lithium ion secondary batteries produced in the following examples and comparative examples were subjected to the following measurements and evaluations. The results of the measurements and evaluations are summarized in Table 1 below.

### (Thickness)

Thickness (μm) was determined as the arithmetic average of thicknesses measured at 20 points using a contact thickness meter (LITEMATIC manufactured by Mitutoyo Corporation). A cylindrical terminal 5 mm in diameter was used as a measuring terminal, and it was adjusted to apply a load of 7 g during the measurement.

### (Average Particle Size of Filler)

The average particle size of a filler was measured using a laser diffraction particle size distribution analyzer. Water was used as a dispersion medium for inorganic fine particles, and a small amount of a nonionic surfactant “Triton X-100” was used as a dispersing agent. In the obtained volume particle size distribution, the central particle size (D50) was defined as the average particle size.

### (Weight Average Molecular Weight of Adhesive Resin)

The weight average molecular weight of an adhesive resin was measured under the following conditions and calculated in terms of polystyrene.

### <Conditions>

GPC: Alliance GPC 2000 [manufactured by Waters Corporation]

Column: TSKgel GMH₆-HT ×2+TSKgel GMH₆-HTL×2 [manufactured by Tosoh Corporation]

Mobile phase solvent: o-Dichlorobenzene

Reference sample: Monodisperse polystyrene [manufactured by Tosoh Corporation]

Column temperature: 140° C.

### (Dynamic Coefficient of Friction)

The surface of an adhesive porous layer of a separator was measured using a surface property tester manufactured by HEIDON.

### (Ten-Point Average Roughness (Rz))

The surface of an adhesive porous layer of a separator was measured in accordance with JIS B 0601-1994 using ET4000 manufactured by Kosaka Laboratory Ltd. The measurement was performed under the following conditions: measurement length: 1.25 mm, measurement speed: 0.1 mm/sec, temperature and humidity: 25° C., 50% RH.

### (Adhesion to Electrodes)

### (1) Production of Positive Electrode and Negative Electrode

A positive electrode and a negative electrode were produced in the same manner as in “Production of Nonaqueous Electrolyte Battery” below.

### (2) Adhesion Test Method

The produced positive electrode and negative electrode were joined together via a separator and impregnated with an electrolyte. The electrolyte-impregnated positive electrode/separator/negative electrode assembly was enclosed in an aluminum laminate pack using a vacuum sealer to produce a test cell. Here, as the electrolyte, 1 M LiPF₆ ethylene carbonate/ethylmethyl carbonate (3/7 mass ratio) was used. The test cell was pressed in a heat press. The cell was then disassembled and measured for peel strength to evaluate adhesion. Pressing was performed at a temperature of 90° C. for 2 minutes under conditions where a load of 20 kg was applied per cm² of electrode.

Peel strength was measured by a method in which the negative electrode and the positive electrode were each separated from the separator by pulling it at an angle of 90° to the separator plane direction at a rate of 20 mm/min using a tensile tester (RTC-1225A manufactured by A&D Company). Adhesion was expressed as a value relative to the peel force in Comparative Example 2 as 100 and shown in Table 1 below.

### (Electrolyte Retention)

The weight of a separator cut to 100 mm×50 mm was defined as W0. The separator was immersed in an electrolyte, 1 M LiPF₆ ethylene carbonate/ethylmethyl carbonate (3/7 mass ratio), for 30 minutes and then taken out, and the electrolyte on the separator surface was wiped off. The separator was then weighed as W1. The amount of electrolyte retention was expressed as W1−W0.

For evaluation, values relative to the amount of retention in Example 1 (W1−W0) as 100 were determined. When the relative value of the amount of retention was 90 or more, a rating of AA was given, when the value was 60 or more and less than 90, A was given, and when the value is less than 60, B was given.

### (Process Yield)

Using roll-to-roll processing in which a rolled separator is fed, conveyed through a plurality of rolls, and rolled up again on another roll, the straight-running properties, wrinkling, and bending in conveying were observed. When the rolling-up conditions were as in Comparative Example 1, a rating of “A” was given, and when straight-running properties are better with less wrinkling and bending, “AA” was given. When there are more wrinkling and bending, “B” was given, and when there are still more wrinkling and bending, “C” was given. The better the conveying properties, the higher the process yield. Therefore, the conveying properties were used as an index of process yield.

### Example 1

### (Production of Separator)

As a polyvinylidene fluoride resin, the following polymer was used: a vinylidene fluoride/hexafluoropropylene copolymer (=98.9/1.1 [molar ratio], weight average molecular weight: 1,800,000). In addition, magnesium hydroxide having an average particle size of 0.8 μm was used as an inorganic filler. The mass proportion of the filler was 50% (=filler/(filler+polyvinylidene fluoride resin)).

The polyvinylidene fluoride resin and magnesium hydroxide in the above ratio were dissolved to a concentration of 5 mass % in a mixed solvent of dimethylacetamide and tripropylene glycol (=7/3 [mass ratio]) to prepare a coating liquid. Both sides of a polyethylene microporous membrane (thickness: 9 μm, Gurley number: 160 sec/100 cc, porosity: 43%) were coated with the same amount of the obtained coating liquid. Next, a coagulation liquid obtained by mixing water, dimethylacetamide, and tripropylene glycol (=57/30/13 [mass ratio]) was prepared, and the coated polyethylene microporous membrane was immersed in the coagulation liquid (40° C.) to cause solidification.

It was then washed with water and dried to give a separator having an adhesive porous layer made of a polyvinylidene fluoride resin formed on both sides of a polyolefin microporous membrane.

### (Production of Nonaqueous Electrolyte Battery)

### (1) Production of Negative Electrode

300 g of artificial graphite as a negative electrode active material, 7.5 g of an aqueous dispersion containing 40 mass % a modified styrene-butadiene copolymer as a binder, 3 g of carboxymethyl cellulose as a thickener, and an appropriate amount of water were stirred in a double-arm mixer to prepare a slurry for a negative electrode. The slurry for a negative electrode was applied to a 10-μm-thick copper foil as a negative electrode collector, dried, and then pressed to give a negative electrode having a negative electrode active material layer.

### (2) Production of Positive Electrode

89.5 g of a lithium cobalt oxide powder as a positive electrode active material, 4.5 g of acetylene black as a conductive auxiliary, and 6 g of polyvinylidene fluoride as a binder were dissolved in N-methyl-pyrrolidone (NMP) to a polyvinylidene fluoride concentration of 6 mass %, and stirred in a double-arm mixer to prepare a slurry for a positive electrode. The slurry for a positive electrode was applied to a 20-μm-thick aluminum foil as a positive electrode collector, dried, and then pressed to give a positive electrode having a positive electrode active material layer.

### (3) Production of Battery

A lead tab was welded to the positive electrode and the negative electrode. Then, the positive electrode, the separator, and the negative electrode were stacked in this order and joined together, impregnated with an electrolyte, and enclosed in an aluminum pack using a vacuum sealer. As the electrolyte, a 1 M LiPF₆ mixed solution obtained by mixing ethylene carbonate (EC) and ethylmethyl carbonate (DMC) in a mass ratio of 3:7 (=EC:DMC) was used.

Using a hot press, a load of 20 kg per cm² of electrode was applied to the aluminum pack having enclosed therein the electrolyte, and the aluminum pack was hot-pressed at 90° C. for 2 minutes to produce a test battery (lithium ion secondary battery).

### Examples 2 and 3

Separators were produced in the same manner as in Example 1, except that the dynamic coefficient of friction and Rz were adjusted by changing the filler mass content to the values shown in Table 1. Test batteries (lithium ion secondary batteries) were then produced.

### Examples 4 to 7

Separators were produced in the same manner as in Example 1, except that the dynamic coefficient of friction and Rz were adjusted by changing the weight average molecular weight of a polyvinylidene fluoride resin to the values shown in Table 1. Test batteries (lithium ion secondary batteries) were then produced.

### Examples 8 and 9

Separators were produced in the same manner as in Example 1, except that the dynamic coefficient of friction and Rz were adjusted by changing the filler to a crosslinked polymethyl methacrylate having an average particle size of 2 μm, and also changing the filler mass content to the values shown in Table 1. Test batteries (lithium ion secondary batteries) were then produced.

### Example 10

A separator was produced in the same manner as in Example 3, except that the dynamic coefficient of friction and Rz were adjusted by changing the filler to a crosslinked polymethyl methacrylate having an average particle size of 3 μm. A test battery (lithium ion secondary battery) was then produced.

### Example 11

A separator was produced in the same manner as in Example 1, except that only one side was coated with a slurry containing a polyvinylidene fluoride resin and magnesium hydroxide. A test battery (lithium ion secondary battery) was then produced.

### Example 12

A separator was produced in the same manner as in Example 1, except that the dynamic coefficient of friction and Rz were adjusted by not using a filler and using a coagulation liquid obtained by mixing water, dimethylacetamide, and tripropylene glycol (water/dimethylacetamide/tripropylene glycol =57/31/12 [mass ratio]). A test battery (lithium ion secondary battery) was then produced.

### Example 13

A separator was produced in the same manner as in Example 12, except that the dynamic coefficient of friction and Rz were adjusted by adjusting the proportion of tripropylene glycol, which is a phase-separating agent, and the coagulation temperature as shown in Table 1. A test battery (lithium ion secondary battery) was then produced.

### Example 14

A separator was produced in the same manner as in Example 1, except that the vinylidene fluoride resin was changed to an aqueous emulsion of a styrene-butadiene copolymer, and a slurry having an inorganic filler content adjusted to 50 mass % based on the total weight of the polymer and the inorganic filler was applied to the polyethylene microporous membrane, followed by drying without using a coagulation liquid. A test battery (lithium ion secondary battery) was then produced. The obtained separator had a thickness of 12 μm, a dynamic coefficient of friction of 0.40, and an Rz of 4.0 μm.

### Comparative Example 1

A separator was produced in the same manner as in Example 1, except that the dynamic coefficient of friction and Rz were adjusted by changing the filler mass content to 90%. A test battery (lithium ion secondary battery) was then produced.

### Comparative Example 2

A separator was produced in the same manner as in Example 8, except that the dynamic coefficient of friction and Rz were adjusted by changing the filler mass content to 50%. A test battery (lithium ion secondary battery) was then produced.

### Comparative Examples 3 and 4

A separator was produced in the same manner as in Example 12, except that the dynamic coefficient of friction and Rz were adjusted by adjusting the proportion of tripropylene glycol, which is a phase-separating agent, and the coagulation temperature. A test battery (lithium ion secondary battery) was then produced.

### Comparative Example 5

A separator was produced in the same manner as in Example 10, except that the dynamic coefficient of friction and Rz were adjusted by changing the filler mass content to 30%. A test battery (lithium ion secondary battery) was then produced.

### Comparative Example 6

Polyvinylidene fluoride (Kynar 720) was dissolved in a mixed solvent of dimethylacetamide (DMAc) and tripropylene glycol (TPG) (DMAc:TPG=50:50 [mass ratio]) to give a slurry for coating. Incidentally, the slurry for coating has a polyvinylidene fluoride concentration of 5.5 mass %.

A separator was produced in the same manner as in Example 1 except for using this slurry for coating. A test battery (lithium ion secondary battery) was then produced.

TABLE 1

| | Adhesive Porous Layer | | | | | | | |
|---|---|---|---|---|---|---|---|---|
| | | | Filler | | | | | |
| | | | | Average | | | Phase-Separating | Coagulation |
| | Adhesive Resin | | | Particle Size | Content | | Agent Concentration | Temperature |
| | Kind | Mw | Kind | [μm] | [mass %] | Coating | [mass %] | [° C.] |
| Example 1 | PVDF | 1,800,000 | Mg(OH)₂ | 0.8 | 50 | Both sides | 30 | 40 |
| Example 2 | PVDF | 1,800,000 | Mg(OH)₂ | 0.8 | 30 | Both sides | 30 | 40 |
| Example 3 | PVDF | 1,800,000 | Mg(OH)₂ | 0.8 | 10 | Both sides | 30 | 40 |
| Example 4 | PVDF | 300,000 | Mg(OH)₂ | 0.8 | 50 | Both sides | 30 | 40 |
| Example 5 | PVDF | 600,000 | Mg(OH)₂ | 0.8 | 50 | Both sides | 30 | 40 |
| Example 6 | PVDF | 1,000,000 | Mg(OH)₂ | 0.8 | 50 | Both sides | 30 | 40 |
| Example 7 | PVDF | 3,000,000 | Mg(OH)₂ | 0.8 | 50 | Both sides | 30 | 40 |
| Example 8 | PVDF | 1,800,000 | PMMA | 2.0 | 35 | Both sides | 30 | 40 |
| Example 9 | PVDF | 1,800,000 | PMMA | 2.0 | 2 | Both sides | 30 | 40 |
| Example 10 | PVDF | 1,800,000 | PMMA | 3.0 | 10 | Both sides | 30 | 40 |
| Example 11 | PVDF | 1,800,000 | Mg(OH)₂ | 0.8 | 50 | One side | 30 | 40 |
| Example 12 | PVDF | 1,800,000 | Absent | | | Both sides | 28 | 40 |
| Example 13 | PVDF | 1,800,000 | Absent | | | Both sides | 20 | 30 |
| Comparative | PVDF | 1,800,000 | Mg(OH)₂ | 0.8 | 90 | Both sides | 30 | 40 |
| Example 1 | | | | | | | | |
| Comparative | PVDF | 1,800,000 | PMMA | 2 | 50 | Both sides | 30 | 40 |
| Example 2 | | | | | | | | |
| Comparative | PVDF | 1,800,000 | Absent | | | Both sides | 30 | 45 |
| Example 3 | | | | | | | | |
| Comparative | PVDF | 1,800,000 | Absent | | | Both sides | 20 | 45 |
| Example 4 | | | | | | | | |
| Comparative | PVDF | 1,800,000 | PMMA | 3 | 30 | Both sides | 30 | 40 |
| Example 5 | | | | | | | | |

| | | | | | | |
|---|---|---|---|---|---|---|
| Comparative | PVDF | 300,000 | Absent | Both sides | 50 | 40 |
| Example 6 | | | | | | |

| | Separator | | | Evaluation | | |
|---|---|---|---|---|---|---|
| | | Dynamic | | | Electrolyte | |
| | Thickness | Coefficient of | Rz | Adhesion to | Retention | |
| | [μm] | Friction | [μm] | Electrodes | Amount | Yield |
| Example 1 | 12 | 0.30 | 4.0 | 200 | AA | AA |
| Example 2 | 12 | 0.32 | 2.6 | 200 | AA | AA |
| Example 3 | 12 | 0.35 | 1.5 | 200 | AA | AA |
| Example 4 | 12 | 0.24 | 4.3 | 150 | AA | A |
| Example 5 | 12 | 0.26 | 4.2 | 160 | AA | A |
| Example 6 | 12 | 0.28 | 4.1 | 180 | AA | AA |
| Example 7 | 12 | 0.18 | 7.1 | 180 | A | A |
| Example 8 | 14 | 0.15 | 4.5 | 170 | AA | AA |
| Example 9 | 13 | 0.20 | 1.0 | 160 | AA | AA |
| Example 10 | 15 | 0.15 | 7.0 | 180 | AA | AA |
| Example 11 | 10.5 | 0.30 | 4.0 | 130 | B | A |
| Example 12 | 12 | 0.50 | 1.2 | 200 | A | A |
| Example 13 | 12 | 0.22 | 4.0 | 200 | A | AA |
| Comparative | 12 | 0.15 | 8.50 | 90 | B | A |
| Example 1 | | | | | | |
| Comparative | 14 | 0.09 | 5.0 | 100 | A | B |
| Example 2 | | | | | | |
| Comparative | 12 | 0.70 | 1.1 | 200 | B | C |
| Example 3 | | | | | | |
| Comparative | 12 | 0.60 | 0.9 | 200 | B | C |
| Example 4 | | | | | | |
| Comparative | 15 | 0.10 | 9.0 | 110 | A | B |
| Example 5 | | | | | | |
| Comparative | 12 | 0.60 | 0.9 | 120 | B | B |
| Example 6 | | | | | | |

As shown in Table 1 above, in the examples, because the dynamic coefficient of friction and Rz of the separators were adjusted to be within predetermined ranges, the yield was higher and also the adhesion to electrodes and electrolyte retention were better than in the comparative examples. Incidentally, also in Example 14, the evaluation results at the same level as in Example 1 were obtained.

1. A separator for a nonaqueous electrolyte battery, comprising a porous substrate and an adhesive porous layer that is provided on one side or both sides of the porous substrate and contains an adhesive resin,
the separator having, on a surface of the adhesive porous layer, a dynamic coefficient of friction of 0.1 or more and 0.6 or less and a ten-point average roughness (Rz) of 1.0 μm or more and 8.0 μm or less.

2. The separator for a nonaqueous electrolyte battery according to claim 1, wherein the adhesive resin has a weight average molecular weight of 300,000 or more and 3,000,000 or less.

3. The separator for a nonaqueous electrolyte battery according to claim 1, wherein the adhesive resin is a polyvinylidene fluoride resin that is a copolymer obtained by copolymerizing at least vinylidene fluoride and hexafluoropropylene and has a structural unit derived from hexafluoropropylene in an amount of 0.1% or more and 5% or less by mol.

4. The separator for a nonaqueous electrolyte battery according to claim 1, wherein the adhesive porous layer contains a filler, the dynamic coefficient of friction is 0.1 or more and 0.4 or less, and the ten-point average roughness Rz is 1.5 μm or more and 8.0 μm or less.

5. The separator for a nonaqueous electrolyte battery according to claim 1, wherein the adhesive porous layer has a filler content of less than 1 mass % relative to the adhesive resin, the dynamic coefficient of friction is 0.2 or more and 0.6 or less, and the ten-point average roughness Rz is 1.0 μm or more and 6.0 μm or less.

6. A nonaqueous electrolyte battery comprising a positive electrode, a negative electrode, and the separator for a nonaqueous electrolyte battery of claim 1 disposed between the positive electrode and the negative electrode,
an electromotive force thereof being obtained by lithium doping/dedoping.

7. The separator for a nonaqueous electrolyte battery according to claim 2, wherein the adhesive resin is a polyvinylidene fluoride resin that is a copolymer obtained by copolymerizing at least vinylidene fluoride and hexafluoropropylene and has a structural unit derived from hexafluoropropylene in an amount of 0.1% or more and 5% or less by mol.
